(19) United States
(12) Patent Application Publication
(10) Pub. No.: US 2024/0010457 A1
(43) Pub. Date: Jan. 11, 2024

(54) SAMPLE-DISPENSING DEVICE

(71) Applicant: ADHESPACK INDUSTRIA, COMÉRCIO, IMPORTAÇÃO E EXPORTAÇÃO LTDA, São Paulo (BR)

(72) Inventor: Volney Olivato DE CAMARGO, São Paulo (BR)

(21) Appl. No.: 18/028,291

(22) PCT Filed: Sep. 24, 2021
(86) PCT No.: PCT/BR2021/050409

§ 371 Date: Mar. 24, 2023

(30) Foreign Application Priority Data
Sep. 25, 2020 (BR) BR102020019640-5

(51) Int. Cl. B65H 35/10

(52) U.S. Cl. CPC B65H 35/10

(57) ABSTRACT

This invention concerns a sample-dispensing device (10), particularly for single, personalized samples of products such as fragrances, makeup and cosmetics, providing them in a safe and hygienic manner at different sale or exhibition outlets, said samples (30) being arranged on continuous strip coils (31). The sample-dispensing device (10) comprises a body (11) containing an inlet area (12) for the continuous strip (32) and an outlet area (13) for the sample (30) forming a passage channel (14) for the sample inside the body (11); the passage channel (14) for the sample comprises at least one separator (15) positioned inside the body (11) acting with a connecting contour (301) of the sample (30) in order to detach it, one by one, from the continuous strip (32).

This invention concerns a sample-dispensing device, particularly for single, personalized samples of products such as fragrances, makeup and cosmetics, providing them in a safe and hygienice manner at different exhibition or sales outlets.

### DESCRIPTION OF THE STATE OF THE ART

Various sample-dispensing devices for products, including cosmetic products and perfumes, are known to the state of the art. Some of these devices are fully automatic, others semi-automatic while others are fully mechanical.

In document BR 102015010856-7, an automatic sample-dispenser is described which, on the activation of a button, rotates a coil positioning a sample in the correct cutting position, executes the cutting of the sample, separating it from the rest of the coil and making it available to the user. Thus, the user simply has to collect the sample released by the device and use it.

Document EP0790928 describes a semi-automatic label dispenser, comprising an axis on which a label coil is positioned and where the labels are adhered and pulled by parallel rollers equipped with projections that engage the labels, sending them to the automatic cutter. This cutter consists of two cutting blades, one fixed and the other mobile, which act as scissors that cut the label on the spaced-out markings printed on them. In addition, while the label emerges from the dispenser, the adhesive layers of said label are removed by means of the adherent cover that removes at least one of the rollers and other adhesive adherent walls positioned after the cutting region of the labels. The rollers and cutters are moved by means of electric motors and the ideal positioning of the label for cutting on the desired mark is assured by means of sensors.

Document BR 102012028851-6, in turn, concerns a fully mechanical sample-dispensing element. The samples are arranged on continuous strip coils containing equidistant detachable contours to allow for the detachment of at least one sample by the user. The coil is positioned inside the sample-dispensing element or a holder so that the user can pull a sample from the handling area, by rotating the coil. The sample is then detached from the coil by the tensile force exerted by the user who, on pulling it, breaks the fragile points that connect this sample to the previous sample which remains connected to the coil.

So, the sample is detached and a section of the handling area of the subsequent sample is positioned at the outlet opening of the sample-dispensing element so that it can be pulled and detached from the coil. However, because it is an element that dispenses samples in a totally mechanical manner, that is, through the use of the tensile force applied by the user on pulling the sample and breaking the fragile points that connect the sample to the coil, more samples than necessary are usually removed, since the tensile force applied by the user is not always sufficient to break the fragile points that connect the sample to the coil strip and this element does not possess a mechanism that helps to break these fragile points. As a result, the user pulls one sample and gets from the dispenser, two or more connected samples that, later, need to be detached from each other and, more importantly, from the rest of the coil.

Similarly, document FR2890952 concerns a device for dispensing a liquid or pasty product deposited in a holder obtained from a strip arranged on a coil. More specifically, this device is equipped with a strip coil containing a plurality of samples and an applicator able to dispense a quantity of product, by simple contact, in these samples as they are being removed from the device.

In this document, the strip presents, between each holder, a central U-shaped indentation delimiting a flap that forms the receiving area of the product that is applied by the dispenser and, on each side of the flap, two detachable connecting zones are formed. As such, between each indentation a different holder is delineated and a quantity of a liquid or pasty product is applied thereto by the applicator. In order for the strip section of the coil or sample containing the product of interest to be removed from the device, the user pulls this sample by holding a small section of the strip, so that the detachable connecting areas are broken thus releasing the sample.

So, even though this mechanical device dispenses a sample through the tensile force applied by the user on pulling this sample, the handling area available for the user to pull the sample in order to detach it is very small. If excessive tensile force is applied, this handling area is removed before the detachable areas connecting the sample with the coil strip are broken, making it impossible to remove the sample from the device. In addition, in the outlet area of the sample of the device, there is a retaining section, flanked by two chamfer areas, to assist in the breaking of the detachable connecting parts during the traction exerted by the user on taking a sample. However, the retaining area consists of a protruding edge, on the outer part of the device, which is not able to fit with the sample format in order to retain it efficiently. The result is the same problem as previously mentioned, where the tensile force applied by the user removes more than one sample from the device, without separating them from each other and without separating them from the coil strip.

Thus, in fully mechanical sample dispensing devices, the problems concerning the detachment of the samples, one by one, on their removal from the device cause waste and damage, since more samples than necessary are removed due to failure to detach the sample from the rest of the coil. Additionally, hygiene in the handling of the samples is compromised when, on pulling on a sample to remove it from the dispenser, it is necessary to hold the subsequent sample in order to break the detachable connecting areas between the samples and to ensure that only one sample is actually taken from the device. In this case, the sample that remains in the device needs to be handled, thus compromising the hygiene and sanitary safety of the sample-removing process.

In addition, fully mechanical sample-dispensing devices possess robust structures, with elements to assist in breaking the detachable connection zones of the samples positioned on the outer part of the device, making it difficult to position at any sales or demonstration outlet.

### OBJECTIVES OF THE INVENTION

So, this invention seeks to provide a sample-dispensing device capable of separating or detaching, one by one, the samples that are fixed to the coil at the time of their removal from the device, preventing the release of more than one sample due to failure of the cuts or connecting areas of the samples to break.

It is also an aim of this invention, to provide a sample-dispensing device that is compact, mechanical, simple to operate and small in size, allowing for its installation and correct operation on any external or internal flat surface.

### BRIEF DESCRIPTION OF THE INVENTION

The aim of this invention is to provide a sample-dispensing device, said samples being arranged on continuous strip coils, the sample-dispensing device comprising a body containing a section for the continuous strip to enter and an area for the sample to exit forming a passage channel for the sample inside the body; the sample passage channel comprises at least one separator positioned inside the body and acting on a connecting contour of the sample to detach it, one by one, from the continuous strip.

### BRIEF DESCRIPTION OF THE DRAWINGS

FIG. 1—is a first perspective view of the sample-dispensing device, which is the object of this invention;

FIG. 2—is a second perspective view of the sample- dispensing device, which is the object of this invention;

FIG. 3—is a front view of the sample-dispensing device, which is the object of this invention;

FIG. 4—is a rear view of the sample-dispensing device, which is the object of this invention;

FIG. 5a—is a schematic side view of the sample-dispensing device, which is the object of this invention;

FIG. 5b—is an A-A-section view of the device illustrated in FIG. 5a;

FIG. 6—is a schematic side view of the sample-dispensing device, which is the object of this invention, illustrating the passage of the sample material;

FIG. 7—is a schematic view of the sample-dispensing device, which is the object of this invention, illustrating the separation of the samples;

FIG. 8—is a schematic view of the sample on removal from the sample-dispensing device, which is the object of this invention; and

FIGS. 9a-9f—are schematic views of the stages of removing a sample from the sample-dispensing device, which is the object of this invention.

### DETAILED DESCRIPTION OF THE INVENTION

According to one principal embodiment, and as illustrated in the attached figures, the object of this invention consists of a sample-dispensing device 10, specifically samples 30 of fragrances, cosmetics and makeup positioned on continuous strip 32 coils 31. Said coils 31 can be formed of a plurality of samples 30 all containing the same product, for example, a fragrance, or the coil 31 can be formed of a plurality of samples 30 containing different types of product, for example, some comprise fragrances, other samples 30 contain makeup, or other cosmetic products, but all these samples 30 are arranged on the same coil 31.

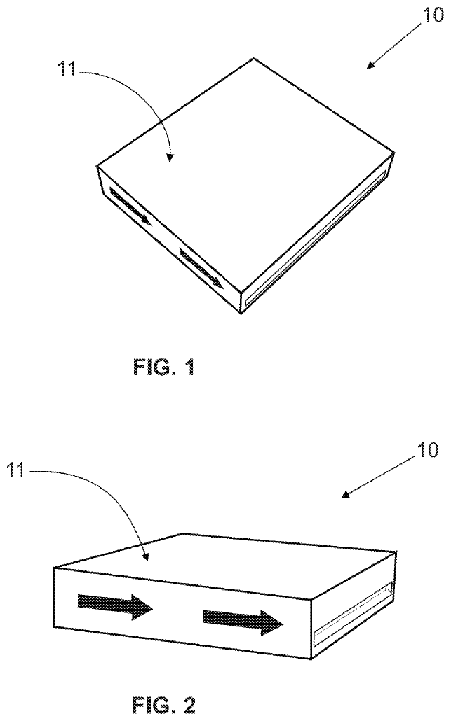

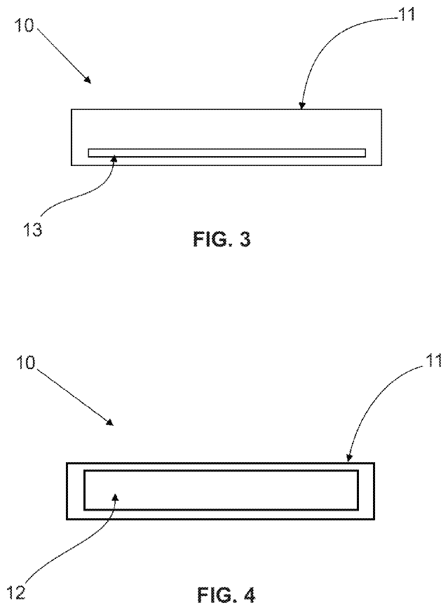

As illustrated in FIGS. 1 to 4, this sample-dispensing device comprises a body 11, formed of a single piece of preferably polymeric material, although other materials can be used, such as rubber, metallic material and composites. This body 11 comprises an inlet part 12 for the continuous strip 32 of the coil 31 and an outlet area 13 for the sample 30, when it is detached from the continuous strip 32.

The inlet part 12 and the outlet part 13 preferably possess the form of flat slots, but other forms may be used for these parts, provided that they allow for the entry of the continuous strip 32 and the exit of the sample 30.

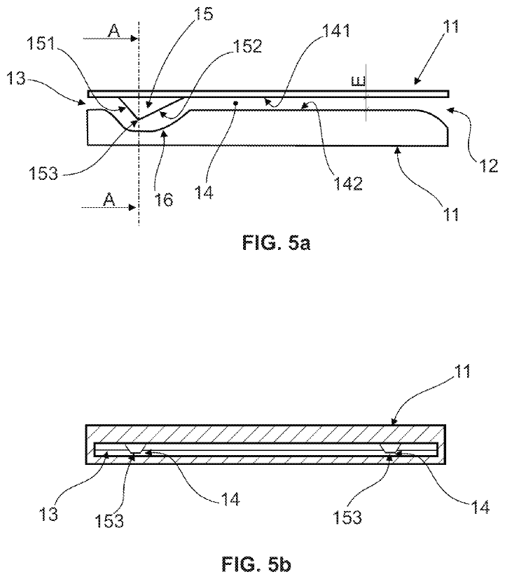

As such, as can be seen in FIGS. 5a and 5b, the entry part 12 of the continuous strip 32 and outlet part 13 of the sample 30 form, inside the body 11 of the device 10, a passage 14 for the sample, whose thickness E is calculated as a function of the thickness of the continuous strip 32 containing the plurality of samples 30. This passage channel 14 of the sample is continuous, connects the entry part 12 with the outlet part 13 inside the body 11, and comprises at least one separator 15 positioned inside the body 11. Said separator acts on a connecting contour 301 of the sample 30, with the aim of detaching the sample 30, one by one, from the continuous strip 32, as shall be explained in detail below.

More specifically, the separator 15 is positioned on a first surface 141 inside the body 11. This separator 15 is formed of a front face 151 that protrudes from the first surface 141 towards the passage channel 14 of the sample and a rear face 152 that also protrudes from the first surface 141 towards the passage channel 14 of the sample. The front face 151 and the rear face 152 intersect with each other such that at the point of intersection a separating edge 153 is formed. In addition, both the front face 151 and the rear face 152 are inclined towards the first surface 141, so that the length of the rear face 152 is greater than the length of the front face 151.

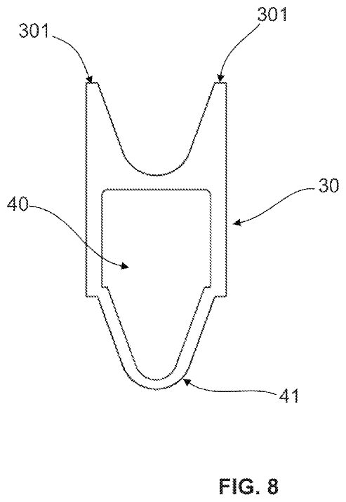

Preferably, the device 10 comprises a pair of separators 15 positioned in alignment and parallel to each other and close to the outlet area 13 of the sample 30, as illustrated in FIGS. 5a and 5b. However, it is possible to position, in alignment and parallel or not, one or more pairs of separators 15 along the first surface 141, provided that these separators 15 can act on a connecting contour 301 of the sample 30 (FIG. 8), with the aim of detaching the sample 30, one by one, from the continuous strip 32.

Moreover, regarding the passage channel 14 of the sample, this comprises a curve 16 arranged on a second surface 142 inside the body 11. This curve 16 is positioned convergently with the position of the separators 15 and its string has a length at least equal to the length of the separators 15, so that the separation edge 153 of each separator 15 is partially housed in the semicircle formed on the second surface 142 by this curve 16, so as to keep constant the thickness E of the passage channel 14 of the sample.

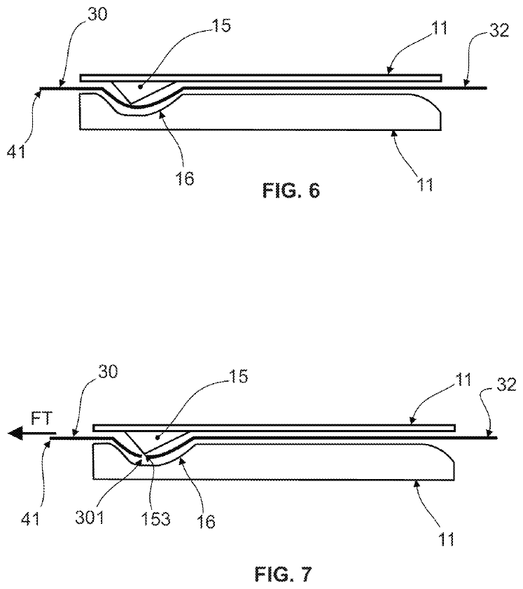

Thus, as illustrated by FIGS. 6 and 7, the continuous strip 32 of the coil 31 is positioned in the passage channel 14 so that the connecting contour 301 of a sample 30 is housed in the curve 16 and the end of the handling section 41 of the sample 30 is positioned outside the outlet area 13. In this position, the separation edge 153 of the separator fits into the connecting contour 301 of the sample 30 which is positioned on the curve 16.

When the sample 30 is subjected to a tensile force FT applied to the handling area 41, the sample 30 is moved within the passage channel 14 toward the outlet area 13 of the device and the separation edges 153 of the separators 15, which are embedded in the connecting contours 301 of the sample 30, break this connecting contour 301 detaching the sample 30 from the continuous strip 32 and releasing this sample 30 for the user.

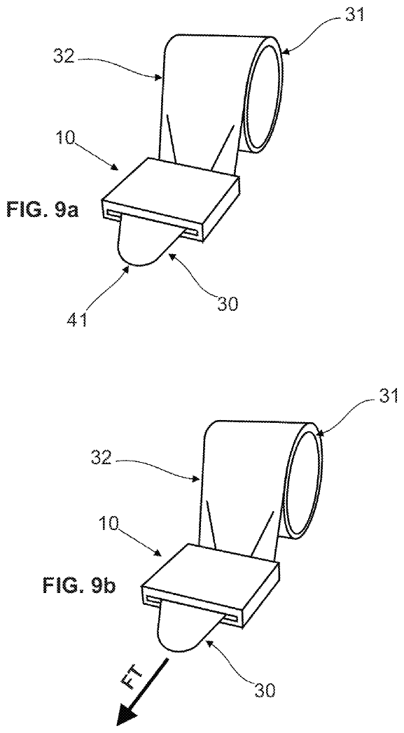

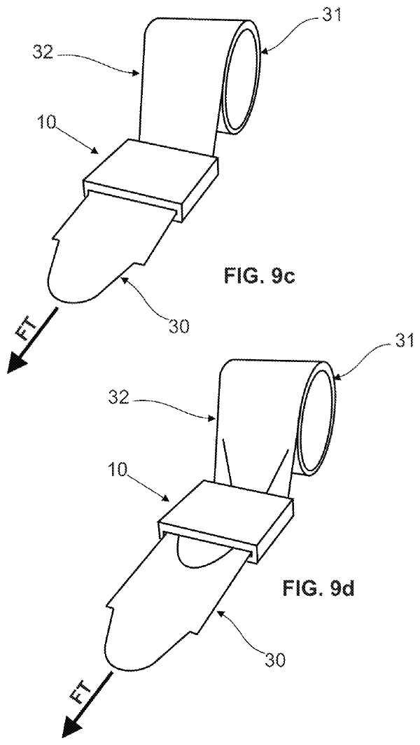

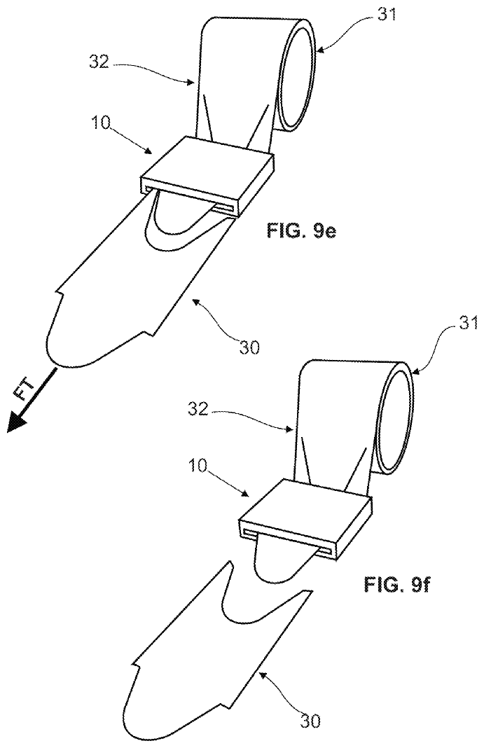

This sequence of actions that results in the release of a sample 30 by the sample-dispensing device 10 is illustrated in FIGS. 9a to 9f. As can be seen in FIG. 9a, initially the continuous strip 32 of the coil 31 is inserted into the sample-dispensing device 10, so that the continuous strip 32 is positioned in the passage channel 14 and one end of the handling section 41 of the sample 30 is arranged in the outlet area 13 for access by the user.

The user then holds the handling section 41 of the sample and applies a tensile force FT, which is to say, it pulls said sample out of the device 10 by holding the handling section 41 of the sample 30, as illustrated in FIG. 9b.

When the tensile force is applied by the user, the sample 30 and continuous strip 32 shift within the passage channel 14, unwinding the coil 31, so that the sample 30 begins to exit the device 10 through the outlet area 13 and the continuous strip 32 is inserted into the device 10 through the input area 12 (FIG. 9c).

Inside the body 11 of device 10, the sample 30 and continuous strip 32 are displaced by the application of the tensile force FT, until the connecting contours 301 of the sample 30 are housed in the curve 14 of the passage channel 14 and meet the separation edges 153 of the separators 15 that fit into the connecting contours 301, as illustrated in FIG. 9d.

With the continuation of the tensile force FT applied by the user, the sample 30 continues to exit the device 10 through the outlet section 13, as illustrated in FIG. 9e, however, due to the fitting and action of the separation edges 153 of the separators 15 in the connecting contours 301 of the sample, these connecting contours 301 are broken, releasing the sample 30 to the user (FIGS. 9e and 9f), at the same time that a new handling end 41 of a new sample 30 is positioned in the outlet section 13 of the device 10.

Although the function of the connecting contours 301 in the samples 30 is to break when the tensile force FT is applied to the sample 30, in many cases the tensile force is not strong enough for this breakage to occur or, what is more, the means of retention in the known devices are not efficient and, therefore, do not aid this breakage.

However, the presence of the separators 15 inside the body 11 of the device 10 that is the object of this invention, and the fitting and action of these separators 15 in the connecting contours 301 of the samples 30, breaking these connecting contours 301 and separating the samples 30, one by one, from the continuous strip 32 still within the body 11 of the device, completely and satisfactorily prevents the release of more than one sample 30 when the tensile force FT is applied by the user. In addition, the action of the separators 15 allows for the breakage of these connecting contours 301 without requiring the user to apply excessive tensile force FT.

Having gained possession of the sample 30 released by the dispense-sampling device 10, the user has access to the product which appears on the upper face 40 of this sample 30, which may be a sample of perfume, a cosmetic product or makeup, and the user simply has to remove the protective film glued, in a non-permanent way, to the upper face 40 (FIG. 8).

With this construction and functionality as described above, the sample-dispensing device 10, which is the object of this invention, is compact, mechanical, easy to operate and small in size, allowing for its installation and correct operation on any flat external or internal surface such as a table edge, a small shelf, a store wall, or inserted into a dispenser or dispensing box, among other surfaces.

So, having described an example of a preferred embodiment, it should be understood that the scope of this invention covers other possible variations, being limited only by the content of the attached claims, including the possible equivalents.

1. A sample-dispensing device, said samples being arranged on continuous strip coils, the sample-dispensing device comprising a body containing an inlet area for the continuous strip and an outlet area for the sample forming a passage channel for the sample inside the body; the sample-dispensing device being characterized by the fact that the passage channel for the sample comprises at least one separator positioned inside the body and acting with a connecting contour of the sample in order to detach it, one by one, from the continuous strip.

2. The device according to claim 1, wherein the separator is positioned on a first surface inside the body, said separator being formed by a front face that protrudes from the first surface towards the passage channel of the sample and a rear face that also protrudes from the first surface towards the passage channel of the sample, the front face and the rear face converging with each other and forming a separation edge.

3. Device, The device according to claim 2, wherein the passage channel of the sample is continuous and connects the inlet area with the outlet part, inside the body.

4. Device, The device according to claim 3, wherein the passage channel of the sample comprises a curve positioned on a second surface inside the body, said curve being positioned convergently with the separator.

5. The device according to claim 4, wherein the continuous strip of the coil is positioned in the passage channel so that the connecting contour of a sample is housed in the curve.

6. The device according to claim 5, wherein the separation edge fits into the connecting contour of the sample when the connecting contour is positioned on the curve.

7. The device according to claim 6, wherein the separation edge breaks the connecting contour of the sample when the sample is subjected to a tensile force (FT).

8. The device according to claim 1, wherein it comprises, preferably, a pair of separators positioned inside the body and acting with connecting contours of the sample, said separators being positioned in alignment and parallel to each other.

9. The device according to claim 1, wherein the body is formed of a single armored piece.

10. The device according to claim 2, wherein it comprises, preferably, a pair of separators positioned inside the body and acting with connecting contours of the sample, said separators being positioned in alignment and parallel to each other.

11. The device according to claim 3, wherein it comprises, preferably, a pair of separators positioned inside the body and acting with connecting contours of the sample, said separators being positioned in alignment and parallel to each other.

12. The device according to claim 4, wherein it comprises, preferably, a pair of separators positioned inside the body and acting with connecting contours of the sample, said separators being positioned in alignment and parallel to each other.

13. The device according to claim 5, wherein it comprises, preferably, a pair of separators positioned inside the body and acting with connecting contours of the sample, said separators being positioned in alignment and parallel to each other.

14. The device according to claim 6, wherein it comprises, preferably, a pair of separators positioned inside the body and acting with connecting contours of the sample, said separators being positioned in alignment and parallel to each other.

15. The device according to claim 7, wherein it comprises, preferably, a pair of separators positioned inside the body and acting with connecting contours of the sample, said separators being positioned in alignment and parallel to each other.
